(19) United States
(12) Patent Application Publication
(10) Pub. No.: US 2008/0246176 A1
(43) Pub. Date: Oct. 9, 2008

(54) PRODUCTION METHOD OF PREFABRICATED ELEMENTS MADE FROM POROUS BUILDING MATERIALS, ESPECIALLY FROM COMPOSITE MATERIALS

(75) Inventors: Jan ZARUBA, Praha (CZ); Pavel Stemberk, Sedlcany (CZ); Tomas Kle Cka, Praha (CZ); Pavel Svoboda, Praha (CZ); Simona Sedlackova, Vsetaty (CZ); Tomas Novotny, Telc (CZ)

Correspondence Address: EGBERT LAW OFFICES, 412 MAIN STREET, 7TH FLOOR, HOUSTON, TX, 77002, US

(73) Assignee: CESKE VYSOKE UCENI TECHNICKE V PRAZE, Praha (CZ)

(21) Appl. No.: 12/060,690

(22) Filed: Apr. 1, 2008

(30) Foreign Application Priority Data
Apr. 4, 2007 (CZ) PV 2007-242

(51) Int. Cl. B29C 70/26

(52) U.S. Cl. 264/115

(57) ABSTRACT

The invention is a method of manufacturing construction precast elements made of porous construction materials, especially composite materials with open structure of pores, cured under normal temperatures, such as concretes, where these construction materials are formed of a mixture of aggregate and bond. Unsorted plastic waste is added into the mixture of aggregate and bond. Such unsorted plastic waste is freed from dirt, crushed and shaped into granules. These granules of plastic waste are mixed into the mixture of construction material before curing. When cured, the resulting precast element is heated to a temperature causing at least part of the granules to melt into a fully liquid state. The resulting composite element is allowed to cool. The plastic waste becomes an additional bond in the precast elements.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The invention deals with a method of manufacturing construction precast elements made of porous construction materials, especially composite materials, with open structure of pores, cured under normal temperatures, such as concretes, where in general these composite construction materials consist of a mixture of aggregate and bond. Simultaneously, this method also involves efficient exploitation of household waste in an unsorted condition aimed to improve mechanical properties and durability of construction materials, concrete in particular, for manufacturing small precast construction elements.

2. Description of Related Art Including Information Disclosed Under 37 CFR 1.97 and 37 CFR 1.98.

Unless simple filling of hollow spaces inside a building structure with household waste material as exploitation of waste in construction industry is considered, current options of exploiting plastic household waste are limited to only sorted plastic waste for manufacturing floor tiles, thermo-insulation boards, support stands of temporary fences, and traffic signs. Manufacturing technologies producing imitation of wood from almost unsorted plastic waste suitable for use as garden furniture, fences, etc. are also known.

Using plastic waste as a component of structural support elements for building structures is at present mostly in the testing stage. Known attempts include adding shredded hard-to-recycle components of plastic waste as a component of concrete aggregate in quantities just under the level imposing negative impact to mechanical properties of concrete. For PET waste, in particular, current efforts show a tendency that the shredded material should be strip-shaped as noodles in hope to improve mechanical properties in similar way as in the case of traditional steel-fiber reinforced concrete.

Until now, the most significant application of using plastic waste as a component of a concrete aggregate is adding shredded expanded polystyrene in order to improve thermo-insulation properties. This application, however, brings major limitations for implementing most commonly used vibration methodologies for compacting the concrete mixture in its mold.

Disadvantages of currently known technologies exploiting plastic material include the requirement for sorted material to be added to construction mixtures as an aggregate, wherein the purpose is to dispose of the waste itself, without regard to improving properties of a given construction material.

### BRIEF SUMMARY OF THE INVENTION

Disadvantages of currently known methods of exploitation of household plastic waste in mixtures of materials used for manufacturing precast construction elements are significantly limited. New advantages and benefits are created, by the method of manufacturing construction precast elements made of porous construction materials with an open structure of pores, cured under normal temperatures, in particular concretes, where such composite construction materials in general consist of a mixture of aggregate and bond according to the presented invention. The principle of the new solution is that another component of aggregate is added into the mixture of aggregate and bond of a given porous construction material. The aggregate mixture is formed as follows: unsorted plastic waste is at first cleaned from dirt, crushed and shaped into form of granules, their maximum diameter shall be at least three times smaller than the minimum thickness of the partitioning wall of construction precast elements, for which the construction material is designed. These plastic waste granules are mixed in the construction material mixture prior its curing in a given mold. When cured, the resulting precast element is heated to temperature, under which at least part of the granules of given plastic waste melts into a fully liquid state. After heating, the resulting composite element is allowed to cool. Also, as an alternative procedure, it is possible to add the plastic waste to a heated precast element by pouring the melted plastic waste onto such precast element. In this way, the part of aggregate formed by plastic waste, which was in fully liquid state, becomes an additional bond.

Granules forming component of aggregate made of plastic waste may be added to the construction material to be cured in a dry or wet condition.

As an advantage, the temperature of heating the precast elements after their initial curing can be set with respect to the used plastic material to allow at least 30% of plastic content of granules forming the component of aggregate made of plastic waste to melt into a fully liquid state.

In one preferred embodiment, the granules forming the component of aggregate made of plastic waste are manufactured by pressing the mixture of crushed plastic waste under high temperatures up to 100° C., which is achieved by cleaning in a water bath when removing remnants of food, oils and soluble dirt.

In one possible embodiment, the granules forming the component of aggregate made of plastic waste are pressed into cylindrical or spherical shape.

Advantageously, granule-shaped plastic materials may be complemented with plastic packages, such as those used for distribution of liquids, in an original shape or melted, in order to create thermo-insulation macrocavities in precast construction elements. These plastic packages may advantageously include, for instance, waste packages made of PET-type material.

The main benefit of the solution according to this invention is that it requires no sorting of waste and that the heat necessary to warm the water for removal of organic remnants from crushed plastic material is exploited to facilitate the process of pressing the granules. Another advantage is that no drying of granules is necessary, rather, on the contrary, residual water content in applied plastic granules desirably increases their average density, thus facilitating options to use vibration methods for compacting the concrete. Moreover, this water content of granules prevents losses of cement bond with respect to undesirable water-flooding of plastic granules by cement paste during compacting the construction precast element in a mold, for example, when manufacturing concrete precast elements.

A completely new benefit of the given solution is that re-melted plastic material acts as an additional bond, which contributes not only to improved mechanical properties, but also it increases chemical stability and durability of a basic support structure of the given material, such as concrete, by their encapsulation into chemically resistant plastic material. Such material shows in particular greater tensile strength, better dynamic absorption and better thermal insulation.

Temperature, to which the construction elements are heated during manufacture in order to activate plastic aggregate to become a plastic bond, is lower than the lowest temperature of gasification of any of plastic components of used granules and therefore only components with lower temperature of gasification, or melting respectively, act as a bond. During fire, the masonry may get heated above this critical temperature. If such a case gasification occurs, the loss of part of the plastic bond occurs respectively, but simultaneously other components of plastic aggregate liquefy and therefore activate as a bond. This means that when the building structure cools down again, such accident may not result in decreased supporting capacity of masonry. It is nevertheless necessary that the system's shape is secured by the first bond, for instance, cement, to be able to preserve a shape of the structure under increased temperatures even for a short time.

### DETAILED DESCRIPTION OF THE INVENTION

As an example of the invention, the embodiment is described as a concrete mixture and manufacture of testing elements serving for verification of assumed basic benefits of the new solution.

Recommended technological procedures are verified by testing beams 15×15×40 cm. Concrete mixture to be used for a basic support structure uses, as aggregate, river gravel with maximum grain size of 1.3 cm and cement to ensure that elements made of this mixture show a standard modulus of elasticity and strength. Plastic granules pressed under temperature of approx. 85° C. into cylindrical or spherical shape with the maximum dimension of approximately 1 cm are added into this basic mixture in scaled testing ratios. For testing purposes, the semi-product for granules is a noodle-shaped crushed material in weight ratios of the following types of plastic materials: PET 50%, PVC 25% and PE 25%. Compacting is achieved by vibrating in a direction of one of the beam's shorter axes, alternatively in a stable position and for 50% of time in opposite position. Beams manufactured as described above are, after 28 days of curing and drying, subject to verification of mechanical, thermal and corrosive properties. These properties are subsequently verified also after heating to scaled temperatures of 150° C., 200° C., 260° C. and 400° C.

### INDUSTRIAL APPLICABILITY

This invention, which was developed following CZ patents Nos. 294646 and 294647, is not suitable solely for improving mechanical properties and durability of small precast elements, but it may also offer significant benefits for the new technology of manufacturing pre-stressed concrete elements according to the Czech CZ patent No. 294213 and benefits for chemical stabilization of construction elements by encapsulating the chemically more aggressive components contained in those construction materials, therefore decreasing undesirable chemical effects under a proper level.

1. A method of manufacturing construction precast elements made of porous construction materials, especially composite materials with open pore structure, cured under normal temperatures, such as concretes, the construction materials being a mixture comprised of aggregate and bond, the method comprising the steps of:
cleaning dirt from unsorted plastic waste;
crushing the plastic waste;
shaping the plastic waste into granules with maximum dimensions at least three times smaller than thickness of a partitioning wall of construction precast elements;
mixing the granules into the construction material;
curing the granule mixture into a precast element heated to a temperature, a portion of the granules melting into a fully liquid state; and
cooling the precast element, forming an aggregate of plastic waste and an additional bond from said fully liquid state.

2. A method of manufacturing according to claim 1, the step of curing the granule mixture being in dry conditions.

3. A method of manufacturing according to claim 1, the step of curing the granule mixture being in wet conditions.

4. A method of manufacturing according to claim 1, wherein said temperature, of the step of curing the granule mixture after is set to allow at least 30% of the granules to form a component of aggregate comprised of plastic waste melted into fully liquid state.

5. A method of manufacturing according to claim 1, the granules being manufactured by pressing the mixture of crushed plastic waste under higher temperature up to 100° C. achieved by cleaning in a water bath when removing remnants of food, oils and soluble dirt.

6. A method of manufacturing according to claim 5, wherein granules forming the aggregate are pressed into cylindrical or spherical shapes.

7. A method of manufacturing according to claim 1, further comprising:
adding plastic containers, during manufacture of construction precast elements, apart from the granules from plastic waste, of PET material, in an original shape or melted state.
